(19) United States
(12) Patent Application Publication
(10) Pub. No.: US 2008/0183752 A1
(43) Pub. Date: Jul. 31, 2008

(54) POWER UNIT EXCHANGE MECHANISMS

(75) Inventor: Kamal Jain, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/668,590

(22) Filed: Jan. 30, 2007

(51) Int. Cl. G06F 17/00; G06F 17/30

(52) U.S. Cl. 707/104.1; 707/E17.009

(57) ABSTRACT

Mechanisms for tracking power unit usage allow power units to be exchanged rather than recharged. Users can purchase power unit subscriptions that are tracked on a per entity basis to allow exchange of power units during the subscription period. The subscriptions can also account for life cycle costs of the power units. Subscriptions can be based on a time period, on an amount of power, and/or on a number of power unit exchanges. In one instance, power unit vending stations interact with a centralized server to allow power unit exchanges at any number of disparate locations.

### BACKGROUND

As society has become more mobile, the requirement for portable power has dramatically increased. Users have become heavily dependent on electrical and electronic devices that can be used without power cords. Portable digital assistants (PDAs), laptops, cell phones and even electric razors now tout freedom from electric cords. This has been possible because of the technological breakthroughs in the size of batteries and other types of power cells. Batteries were originally very large and only produced a few volts and lasted only a short time. Now batteries can use cutting edge battery chemistry such as lithium-ion and lithium-polymer to produce small cells with large watt-hour capacities. But as is typical, with the availability of powerful miniature cells, users have developed a need for even more power. Users constantly demand that their cell phones and laptops run longer between recharging while at the same time their laptops use more power for fancier screens and increased functionality.

The end result is that users spend a large amount of their time hooked to power outlets to recharge their batteries (recharge time is generally in the multiple hours category). And while not hooked to outlets, they spend additional time looking for outlets while traveling. So, although the batteries give a user some amount of freedom, there still is a rather frequent need to obtain additional power, typically through recharging the batteries. Technologies have continued to progress and several companies have introduced the concept of fuel cells to extend mobile freedom from a few hours to a few days. However, the fuel cells are based on volatile fuel that is dangerous to handle and cannot be easily recharged like a common battery is today.

### SUMMARY

A tracking mechanism allows power units to be exchanged rather than recharged when depleted. In one instance, power unit vending stations interact with a centralized server to allow power unit exchanges at any number of disparate locations. Entities (e.g., users, corporations, etc.) can purchase power unit subscriptions that are tracked, for example, on a per user basis to allow exchange of power units during the subscription period. Life cycle costs of a power unit can be disseminated over a subscription period, charged at a time of exchange, and/or purchased at the beginning of the subscription and the like. Subscriptions can be based on a time period (e.g., life cycle of typical power unit), on an amount of power (e.g., purchase 1,000 watt-hours, etc.), and/or on a number of power unit exchanges (e.g., 20 exchanges, etc.). The power unit tracking mechanisms allow substantial flexibility in power unit types (e.g., batteries, fuel cells, power cells, etc.) and fee schemes.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter may be employed, and the subject matter is intended to include all such aspects and their equivalents. Other advantages and novel features of the subject matter may become apparent from the following detailed description when considered in conjunction with the drawings.

### BRIEF DESCRIPTION OF THE DRAWINGS

FIG. 1 is a block diagram of a power unit tracking system in accordance with an aspect of an embodiment.

FIG. 2 is another block diagram of a power unit tracking system in accordance with an aspect of an embodiment.

FIG. 3 is a block diagram of a power unit tracking system interacting with multiple power unit exchange components in accordance with an aspect of an embodiment.

FIG. 4 is a block diagram of a federated power unit tracking system in accordance with an aspect of an embodiment.

FIG. 5 is a flow diagram of a method of tracking power units in accordance with an aspect of an embodiment.

FIG. 6 is a flow diagram of a method of regulating power unit exchanges in accordance with an aspect of an embodiment.

FIG. 7 is a flow diagram of a method of subscribing a power unit exchange program in accordance with an aspect of an embodiment.

FIG. 8 illustrates an example operating environment in which an embodiment can function.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It may be evident, however, that subject matter embodiments may be practiced without these specific details. In other instances, well-known structures and devices are shown in block diagram form in order to facilitate describing the embodiments.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers.

Instances are provided herein that allow tracking of power units to permit exchange rather than recharging of the power units. In some instances, a unique identifier is assigned to a power unit to allow it to be tracked and/or associated with an entity. By employing a centralized mechanism for tracking, the entity can readily exchange a power unit at any location capable of accepting that type of power unit. This allows an entity such as, for example, a user to minimize downtime while using a portable device that requires power. It saves the user from having to carry multiple power units or to constantly hunt for power sources to recharge. It also saves users from the mobile downtime caused by having to be “plugged in” to recharge which substantially limits an electronic device's mobility.

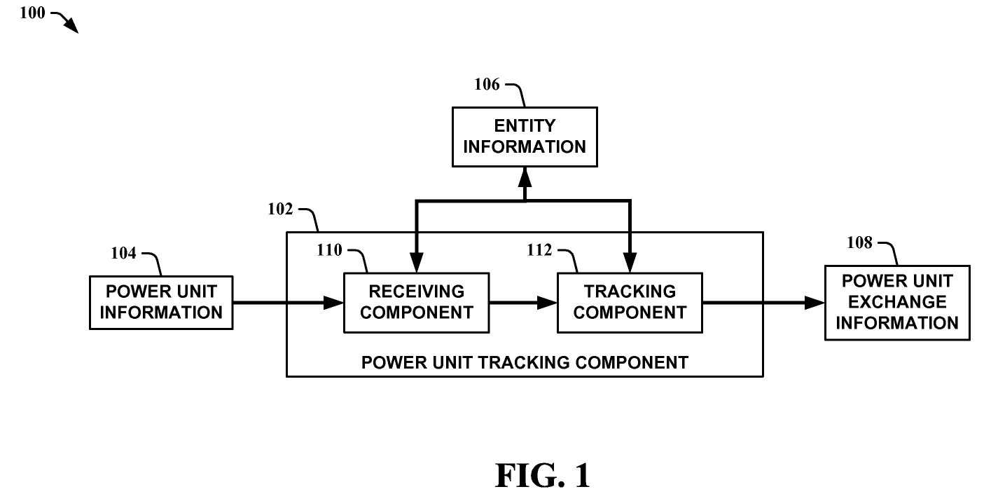

FIG. 1 illustrates a power unit tracking system 100 that employs a power unit tracking component 102 to obtain power unit information 104 and/or entity information 106 and provide power unit exchange information 108. The power unit information 104 can be obtained from remote sources such as a power unit exchange station (e.g., a vending station that exchanges power units, etc.). These power unit exchange stations can be located in airports, service stations, grocery stores, and/or other private and/or public facilities where entities would likely desire to exchange depleted power units for fresh power units. A “power unit” includes, but is not limited to, batteries, power cells, fuel cells and/or other power providing devices that typically have a finite power delivery capability.

A power unit is not limited by chemical composition, size and/or capacity and the like. Thus, a power unit can power, for example, laptops, cell phones, and/or radios and other smaller electronic devices, but it can also power larger devices such as, for example, lawn mowers, vehicles, aircraft, and/or refrigerators and the like. Although current power technologies might not be feasible for some of the above devices, future technologies may permit, for example, power units powerful enough to be utilized for transportation while portable enough to be exchanged at service/fueling stations and the like. Thus, even electric cars can be quickly re-fueled without waiting for internal batteries to be recharged. The instances disclosed herein are not limited by or to current technologies.

Because the power delivery is finite, the power unit is typically recharged periodically. However, some power units are not user-rechargeable due to volatile and/or toxic energy sources utilized in the power units. The power unit tracking system 100 allows power units to be tracked so that they can be easily exchanged at any number of exchange locations. Exchanges can also occur for other reasons such as, for example, broken power units, brand switching, capacity increasing, etc. The exchanges are typically governed by an agreement or subscription with an entity. Some subscriptions cover a life cycle of a typical power unit and allow the entity to exchange the power unit an unlimited number of times during that life cycle period. Other subscriptions can be based on a certain number of exchanges, exchanges permitted based on additional fees paid, and/or a lifetime of exchanges and the like. It can be appreciated that the number of additional types of subscriptions not specifically named here can be infinite and are employable with instances disclosed herein.

The power unit information 104 can include, but is not limited to, a unique identifier, power unit type, capacity, subscription information, life cycle, and/or exchangeability and the like. The entity information 106 can include, but is not limited to, user and/or enterprise information like name, contact information, subscription information, fees paid, fees owed, and/or power unit exchange eligibility and the like. An “entity” can include a single user and/or multiple users such as those within an enterprise, group, club, etc. Thus, subscriptions, discussed infra, can apply to single user entities and/or multiple user entities and the like. The power unit tracking component 102 employs a receiving component 110 and a tracking component 112 to assist with processing of the power unit information 104 and/or the entity information 106. The receiving component 110 can obtain the power unit information 104 and/or the entity information 106 from a variety of sources utilizing different communication means such as for example wired and/or wireless communications.

For example, the receiving component 110 can interact with a power unit exchange station or component (described infra) via the Internet, an intranet, cellular communications and/or other wired/wireless communications and the like. This allows the power unit tracking component 102 to reside in a local and/or remote location in relation to a power unit exchange station. The power unit information 104 and/or entity information 106 can also be obtained from a device that utilizes a power unit (e.g., a cell phone can report its internal power unit information, a laptop can report its internal power unit information, a vehicle can report its power unit information as it approaches a service station, etc.). The tracking component 112 receives the entity information 106 and/or power unit information 104 from the receiving component 110. The tracking component 112 can also receive the entity information 106 directly. In some instances, the functionality of the tracking component 112 can include the functionality of the receiving component 110.

The tracking component 112 analyzes the power unit information 104 and/or the entity information 106 to determine the power unit exchange information 108. The power unit exchange information 108 can include, for example, authorization for a power unit exchange (e.g., does a subscription allow this exchange, etc.), transaction charges for an exchange, permissible power unit unique identifiers (e.g., which type and/or size of battery, etc. can be exchanged), and/or messages for a party involved in the exchange (e.g., subscription expired, invalid power unit, authorization not currently available, etc.) and the like. The power unit exchange information 108 is typically utilized by a power unit exchange component described infra to facilitate regulation of power unit exchanges.

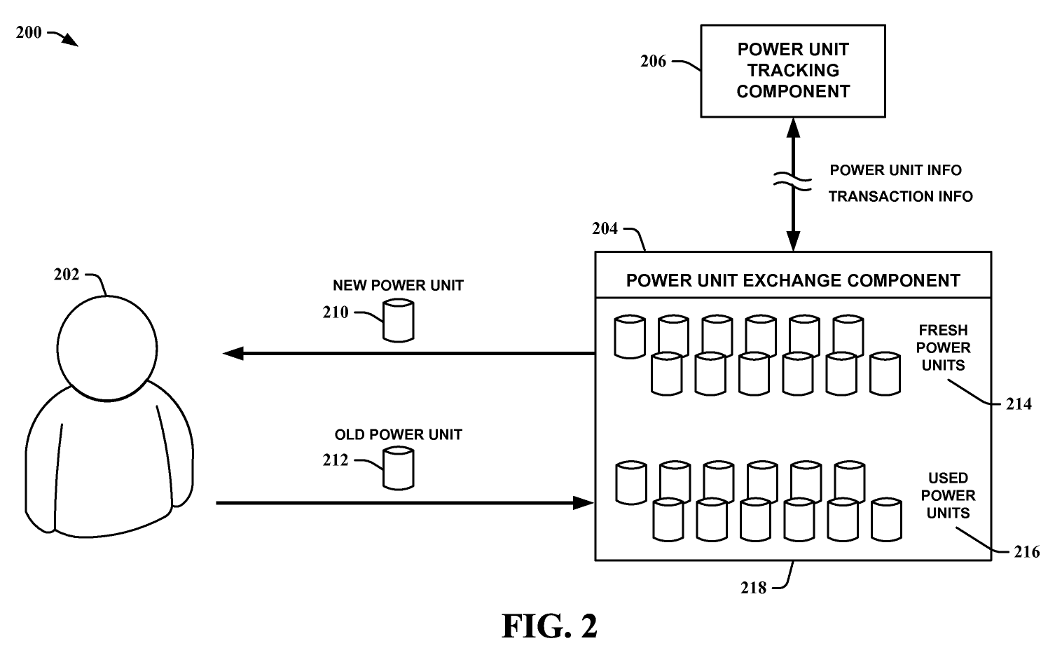

FIG. 2 shows a power unit tracking system 200 that utilizes a power unit tracking component 206 to interact with a power unit exchange component 204. In this example, a user 202 interacts with the power unit exchange component 204 to exchange an old power unit 212 for a new power unit 210. In some instances, the power unit exchange component 204 is co-located with a physical exchange station 218 that accepts used power units 216 and/or stocks fresh power units 214. For example, the power unit exchange component 204 can be resident within a vending machine that accepts and dispenses power units at, for example, an airport and the like. In some instances, the power unit exchange component 204 can include a human who accepts and exchanges power units and interacts (e.g., telephones, enters data into a computing device, etc.) with the power unit tracking component 206.

In a typical scenario, the user 202 approaches the power unit exchange component 204 and relays information about the old power unit 212 to the power unit exchange component 204. This can be done manually by entering a unique serial number from a power unit, scanning a bar code type indicator on the power unit, placing the power unit in proximity of a reader that obtains information stored internally in the power unit, and/or utilizing other recognition techniques so that the power unit exchange component can uniquely identify the old power unit 212. Once the unique power unit identification is obtained, the power unit exchange component 204 can interact with the power unit tracking component 206 to further relay this information to the power unit tracking component 206. The power unit tracking component 206 can analyze the information and reply with power unit exchange information (e.g., transaction information, etc.) back to the power unit exchange component 204. The power unit exchange information can include, for example, authorization to allow the exchange of the old power unit 212 for the new power unit 210, fees that are required to be submitted before the exchange is permitted, and/or rejection of a power unit unique identifier as not eligible for a subscription program and/or for other reasons and the like. Messages can also be generated by the power unit tracking component 206 and/or the power unit exchange component 204 to relay to the user 202 so the user 202 can obtain status information relating to the exchange.

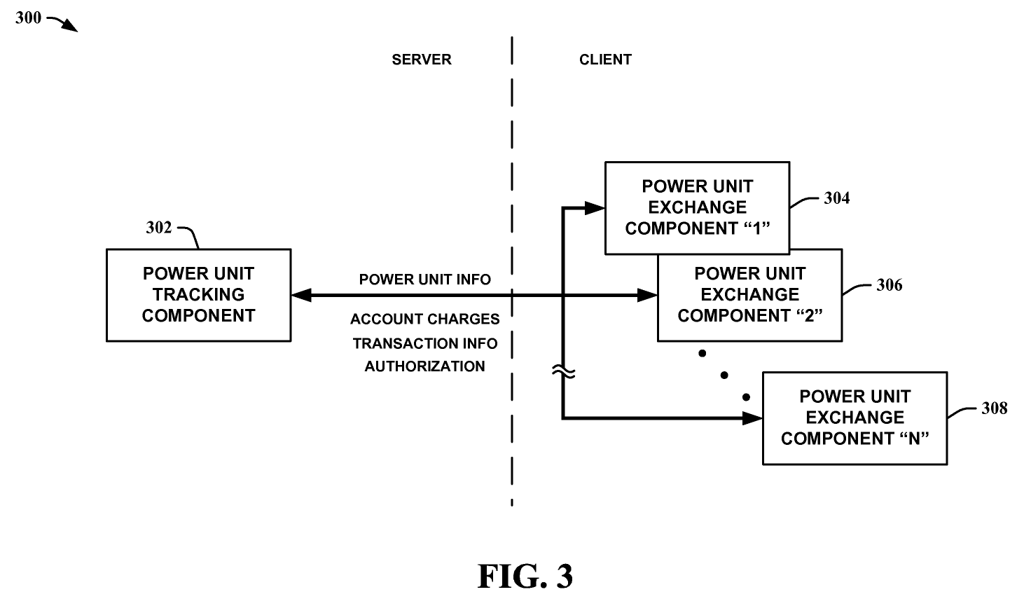

FIG. 3 depicts a power unit tracking system 300 interacting with multiple power unit exchange components “1-N” 304-308, where N represents and integer from one to infinity. In this illustration, the power unit tracking system 300 employs a power unit tracking component 302 that resides in a central location accessible by other remote locations. For example, the power unit tracking component 302 can reside on a server that is accessible by a global communication means (e.g., the Internet, telephonic landlines, cellular communications, satellite communications, etc.) and the like. The power unit exchange components “1-N” 304-308 can reside in disparate locations. This allows, for example, a user to exchange a battery at a departure airport in one city, use the battery in flight and then exchange it again at an arrival airport in a city in a different country. Because the power unit tracking component 302 allows the battery's tracking information to be centrally processed and disseminated, the user can perform a transaction at any place that has an appropriate power unit exchange component (e.g., kiosk, exchange center, vending machine, etc.) that communicates with the power unit tracking component 302.

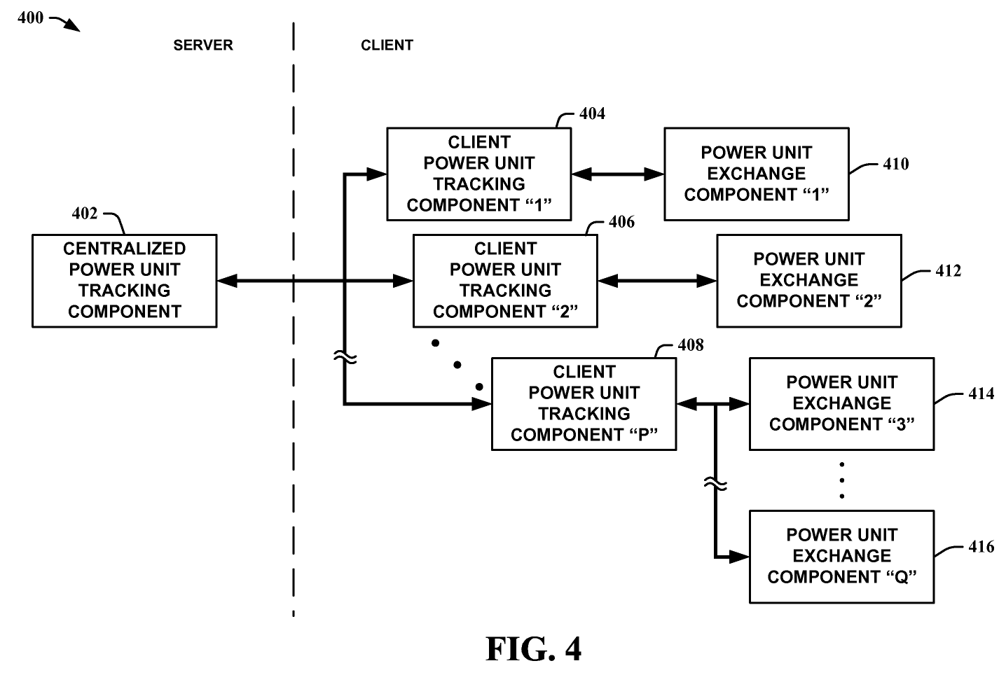

In some examples, communications are not readily available and/or are not continuously available. FIG. 4 illustrates a federated power unit tracking system 400 that can be employed to minimize the impact of limited communications. The federated power unit tracking system 400 utilizes a centralized power unit tracking component 402 that can reside, for example, on a server and the like and client power unit tracking components “1-P” 404-408, where P represents an integer from one to infinity, that can reside local to power unit exchange components “1-Q” 410-416, where P represents an integer from one to infinity. By employing localized client power unit tracking components “1-P” 404-408, power unit exchange information can be stored and/or processed locally. The client power unit tracking components “1-P” 404-408 can then interact with the centralized power tracking component 402 and/or with each other (e.g., in a relay fashion so information can be handed-off and eventually reach the centralized power unit tracking component 402, etc.) when communications are available. This permits power unit exchanges without requiring constant communications with the centralized power unit tracking component 402.

The client power unit tracking components “1-P” 404-408 can be limited to certain types of processing if desired to minimize fraud and/or other abuses that can occur with limited access to a centralized authority. For example, the client power unit tracking components “1-P” 404-408 can create a ‘subnet’ and interact with each other when they are located, for example, within a certain proximity. This can prevent a user from going from one vending machine to another within an airport even without centralized authorization. In this situation, the subnet connected client power unit tracking components “1-P” 404-408 can track amongst themselves which users have exchanged power units and when.

In this illustration, client power unit tracking component “1” 404 interacts with power unit exchange component “1” 410, client power unit tracking component “2” 406 interacts with power unit exchange component “1” 412, and client power unit tracking component “P” 408 interacts with power unit exchange components “3 & Q” 414, 416. Client power unit tracking component “P” 408 illustrates that a client power unit tracking component can also be utilized with multiple power unit exchange components. Thus, a client power unit tracking component can be employed per building, per location, per city, etc. to minimize fraud (e.g., quicker communications and/or better environment awareness can determine fraudulent acts easier, etc.) and/or minimize communication traffic with the centralized power unit tracking component 402 and the like.

The above types of systems are especially useful with types of power units that employ robust shells that can be economically re-used. For example, future technologies indicate that fuel cells might be developed that can be utilized in laptops and other portable devices. The fuel used in fuel-cells is typically too hazardous for users to handle. Fuel cell technology uses a chemical fuel which is converted into electricity using electrodes. For safety, fuel that is highly hazardous, at the very least, is typically sold in cartridges. Currently, many scientists are visualizing that empty cartridges could be exchanged with filled cartridges just like a propane canister. But these cartridges can't be completely sealed or else the seal must be broken in the fuel cell so that electrodes can act as catalyst on the fuel. The point at which either the fuel comes out of the cartridges and/or the electrodes enter the cartridge creates a potentially dangerous situation for the user.

One possible solution is that the fuel cells are sealed in a factory together with the electrodes. This sealed fuel cell has only electricity connections outside. So the only exposed portion of the fuel cell is the electricity connection just like a battery. The downside is that a discharged fuel cell is now a sophisticated piece of equipment that is not user serviceable and can only be recharged in a factory setting. Therefore, the above instances can be employed, for example, to exchange these hazardous power units without harm to a user.

In some situations it can be assumed that each power unit has a unique serial number. Usually, for example, laptop power units have unique serial numbers. This unique serial number can be either be in electronic format on an embedded electronic circuitry and/or it can be physically scribed on the power unit and/or it can be associated with the power unit in any other format. As long as a power unit can't be associated with another serial number and the serial number can't be associated with another power unit, it is unique for the instances described herein.

In one scenario, a user who wants to utilize a service of exchanging a discharged power unit with a charged power unit can purchase a power unit which can participate in a subscription program. At the time of purchase of the power unit, the user's account can be associated with the power unit unique identifier. This association can either be stored, for example, on computers (such as servers) and/or it can even be stored on the electronic circuitry embedded on the power unit and the like. Whenever a user exchanges the power unit, the serial number of the replaced power unit is associated with the user's account.

Whenever a user purchases a new participating power unit, it can come with, for example, a lifetime usage warranty, where a lifetime is typically the number of years for which the power unit is manufactured for. This expiry date is also associated with the user's account. That means the user is guaranteed the use of the power unit and/or the replaced power unit until that expiry time. When the user exchanges the power unit and the replaced power unit has a closer expiry time—then that would be immaterial to the user. The user can be allowed to exchange the power unit before the expiry of the original power unit. In other scenarios, the power unit can have a counter which keeps track of the number of recharges, and then the usage can also be guaranteed in terms of a number of recharges. The number of recharges a user has used can also be tracked with the user's account.

The fee of this service could also be tracked in the user account. There are various fee models. For an example, fee could be charged for each exchange. A lifetime exchange fee could be charged with the first battery. Or a periodic subscription fee can be charged every period like, for example, every month or year. Other accounting mechanism can also be associated with the user's account. Since a serial number is associated with the battery, it is not really necessary to inspect a power unit at the time of exchange. If a power unit breaks, a user can exchange it and, at the time of exchange, can report the fact that the power unit broke so that the power unit can be taken out of the cycle.

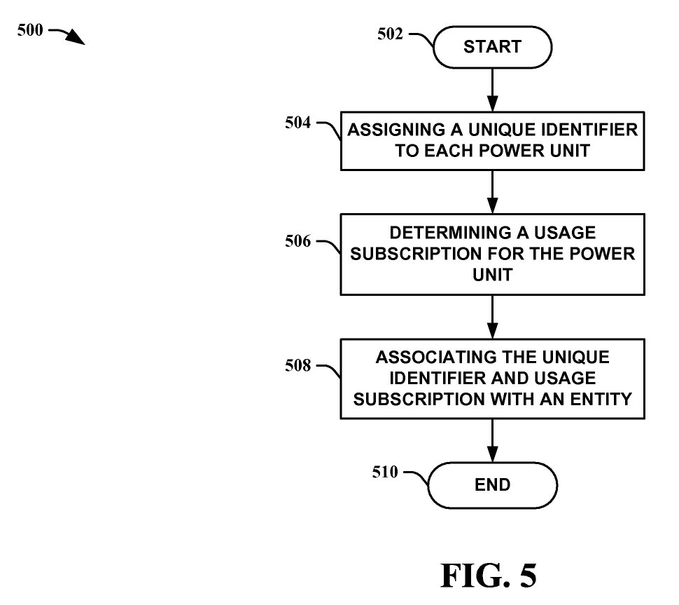

In view of the exemplary systems shown and described above, methodologies that may be implemented in accordance with the embodiments will be better appreciated with reference to the flow charts of FIGS. 5-7. While, for purposes of simplicity of explanation, the methodologies are shown and described as a series of blocks, it is to be understood and appreciated that the embodiments are not limited by the order of the blocks, as some blocks may, in accordance with an embodiment, occur in different orders and/or concurrently with other blocks from that shown and described herein. Moreover, not all illustrated blocks may be required to implement the methodologies in accordance with the embodiments.

The embodiments may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the embodiments.

In FIG. 5, a flow diagram of a method 500 of tracking power units in accordance with an aspect of an embodiment is shown. The method 500 starts 502 by assigning a unique identifier to each power unit 504. The unique identifier can be a mechanism added to a power unit and/or a mechanism that utilizes an aspect of the power unit itself. For example, a serial number can be assigned to a power unit and/or a shape and/or other characteristic of the power unit can be determined to be the identifier (e.g., brand X only makes power unit Z in green and black packaging and/or a AA size battery is the only exchangeable power unit they produce, etc.). The unique identifier can be part of a power unit packaging (e.g., printed on a label, bar coded on the power unit, etc.) and/or embedded into a power unit (e.g., electronically stored on the power unit, RFID tagged, etc.).

A usage subscription is then determined for the power unit 506. A usage subscription can be determined based upon the type of a power unit (e.g., all AA size and/or certain brands are subscribed for two years, etc.) and/or based on a specific entity (e.g., all employees of corporation A have an automatic three year subscription, a specific user has purchased a lifetime battery, etc.) and the like. The unique identifier and usage subscription are associated with an entity 508, ending the flow 510. Association of the subscription and entity allows the entity to utilize disparate exchange locations without being required to know and/or have an alternative means to communicate their subscriptions each time they desire to exchange a power unit. Additionally, unique identifiers for exchanged power units can then be associated to the specific entity to keep the associations up-to-date.

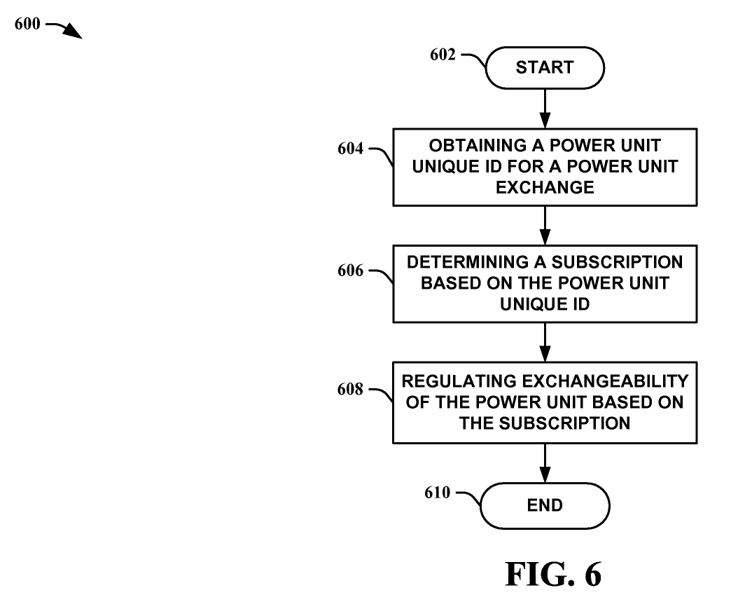

Turning to FIG. 6, a flow diagram of a method 600 of regulating power unit exchanges in accordance with an aspect of an embodiment is illustrated. The method 600 starts 602 by obtaining a power unit unique ID for a power unit exchange 604. The power unit unique ID is typically obtained at an exchange station where an entity desires to receive a fresh power unit. The entity can enter the power unit unique ID into a terminal and/or use a reading device such as, for example, an optical scanner and the like to input the power unit unique ID. A subscription is then determined based on the power unit unique ID 606. The power unit unique ID is then processed to determine if a subscription is associated with that particular power unit unique ID. This is typically done at a centralized location so that exchange and/or subscription information is current, but it can also be processed local to an exchange station and the like. The subscription, entity, and/or exchange count, etc. can also be stored on the power unit itself. Exchangeability of the power unit is then regulated based on the subscription 608, ending the flow 610. Based on the power unit unique ID and the subscription, it can be determined, for example, if the subscription is paid-up, if the exchange is eligible, and/or if the entity is correct and the like. Thus, the entity could be required to submit additional payments to perform the exchange, the entity could receive a notice that the exchange is not permitted, and/or the entity could be warned that they are not the owner of the power unit and the like.

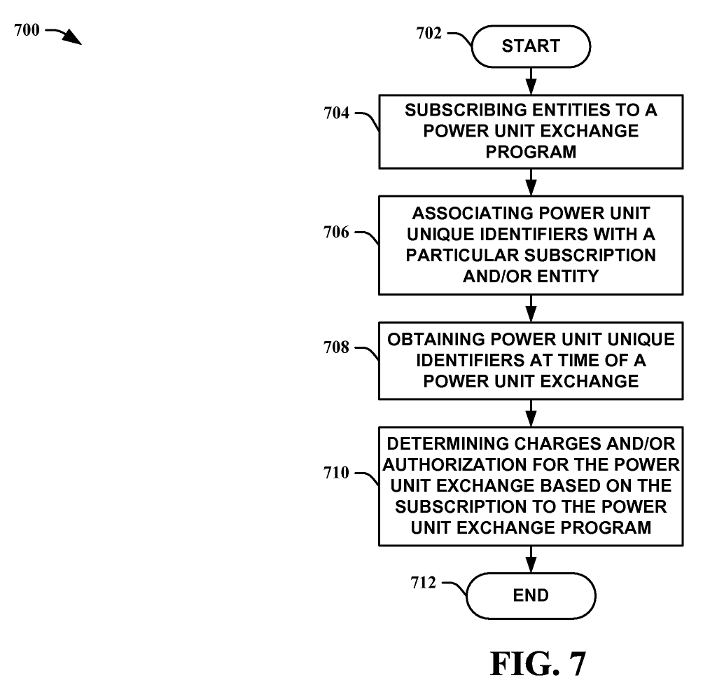

Looking at FIG. 7, a flow diagram of a method 700 of subscribing a power unit exchange program in accordance with an aspect of an embodiment is depicted. The method 700 starts 702 by subscribing entities to a power unit exchange program 704. This can be accomplished, for example, by providing a subscription automatically with a power unit purchase, requiring an entity to subscribe after a power unit purchase to activate the power unit, and/or as an optional enticement to allow an entity additional use of a rented and/or purchased power unit and the like. One can appreciate that a limitless number of promotions can be envisioned for providing subscriptions for the power units are employable with instances provided herein. Subscriptions can be based on a single entity and/or an entity comprised of multiple users such as an enterprise and the like. Thus, a subscription can be for a particular power unit type and/or cover all power unit types for a particular entity and the like.

Power unit unique identifiers are associated with a particular subscription and/or entity 704. Association of the power unit unique identifier facilitates in tracking of the power units. Power unit unique identifiers are obtained at time of a power unit exchange 706. When entities desire to exchange their power units, the power unit unique identifier facilitates the process and, thus, is obtained at this time. Power unit exchange charge determinations and/or authorizations are based on the subscription to the power unit exchange program 708, ending the flow 710. The terms of the subscription controls how the exchange program is executed. The subscription can limit a total number of exchanges, a frequency of exchanges, a cost associated with each exchange, and/or additional authorizations required before exchange and the like. For example, a subscription for an entity comprising an enterprise could require that covered power unit exchanges (e.g., authorized by the subscription agreement) be additionally authorized by the entity itself (e.g., the enterprise desires to control power unit exchanges of its employees, etc.). Thus, additional authorization of the entity could be required even though the power unit is allowed per the subscription and the like. For example, corporation A might want to authorize 100 exchanges per year (in the subscription) but they do not want them used by, for example, their janitorial staff because their sales staff needs those exchanges for their laptops, etc.

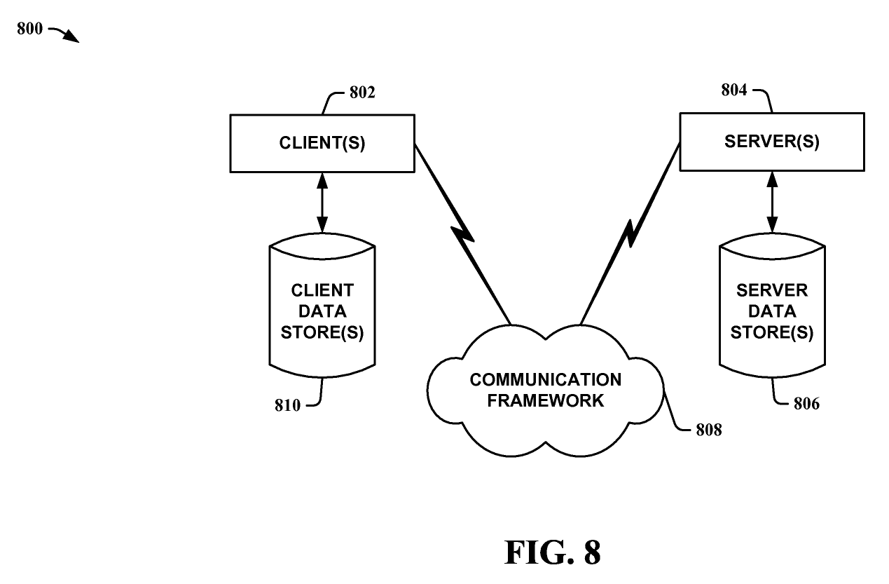

FIG. 8 is a block diagram of a sample computing environment 800 with which embodiments can interact. The system 800 further illustrates a system that includes one or more client(s) 802. The client(s) 802 can be hardware and/or software (e.g., threads, processes, computing devices). The system 800 also includes one or more server(s) 804. The server(s) 804 can also be hardware and/or software (e.g., threads, processes, computing devices). One possible communication between a client 802 and a server 804 can be in the form of a data packet adapted to be transmitted between two or more computer processes. The system 800 includes a communication framework 808 that can be employed to facilitate communications between the client(s) 802 and the server(s) 804. The client(s) 802 are connected to one or more client data store(s) 810 that can be employed to store information local to the client(s) 802. Similarly, the server(s) 804 are connected to one or more server data store(s) 806 that can be employed to store information local to the server(s) 804.

It is to be appreciated that the systems and/or methods of the embodiments can be utilized in power unit tracking facilitating computer components and non-computer related components alike. Further, those skilled in the art will recognize that the systems and/or methods of the embodiments are employable in a vast array of electronic related technologies, including, but not limited to, computers, servers and/or handheld electronic devices, and the like.

What has been described above includes examples of the embodiments. It is, of course, not possible to describe every conceivable combination of components or methodologies for purposes of describing the embodiments, but one of ordinary skill in the art may recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that tracks power units, comprising:
a receiving component that obtains power unit information and/or entity information; and
a power unit tracking component that employs the power unit information and/or entity information to track power units associated with an entity.

2. The system of claim 1 further comprising:
a power unit exchange component that interacts with an entity to exchange power units and to obtain power unit information and/or entity information for the power unit tracking component.

3. The system of claim 2, the power unit exchange component resides within an electronic mobile device and provides power unit information when communications are established with the power unit tracking component.

4. The system of claim 1, the power unit comprising a battery, a fuel cell and/or a power cell.

5. The system of claim 1, the entity comprising an individual user and/or an enterprise.

6. The system of claim 1, the power unit tracking component comprising a federated system of tracking components that report to a centralized tracking component, each federated tracking component interacting with at least one power unit exchange component.

7. The system of claim 1, the power unit tracking component comprising a centralized tracking component that interacts with at least one power unit exchange component.

8. The system of claim 1, the power unit tracking component further authorizes power unit exchanges based on a subscription exchange allotment, a subscription time period, and/or a subscription power allotment.

9. The system of claim 1, the receiving component obtains power unit information, exchange information, and/or entity information from a power unit.

10. The system of claim 1 further comprising:
a power unit exchange component that interacts with an entity to exchange power units and to obtain power unit information and/or entity information for the power unit tracking component.

11. A method for tracking power units, comprising:
assigning a unique identifier to each power unit;
determining a usage subscription for the power unit; and
associating the unique identifier and usage subscription with a user.

12. The method of claim 11 further comprising:
storing the associated information on a server and/or on a power unit.

13. The method of claim 12 further comprising:
scribing the associated information on a power unit.

14. The method of claim 12 further comprising:
electronically embedding the associated information within a power unit.

15. The method of claim 11 further comprising:
regulating exchanges of power units based on the usage subscription; and
associating exchanged power unit unique identifiers with the user.

16. The method of claim 11 further comprising:
utilizing time and/or recharge cycles to determine the usage subscription.

17. The method of claim 11 further comprising:
charging fees based on exchanging power units within the usage subscription.

18. A system that tracks exchanged power units, comprising:
means for obtaining a unique identifier from an exchanged power unit and/or user information associated with the exchanged power unit; and
means for employing the exchanged power unit information and/or user information to regulate power units exchanged by the user based on a subscription agreement.

19. A device employing the method of claim 11 comprising a computer, a server, and/or a handheld electronic device.

20. A device employing the system of claim 1 comprising a computer, a server, and/or a handheld electronic device.
